(19) United States
(12) Patent Application Publication
(10) Pub. No.: US 2023/0351901 A1
(43) Pub. Date: Nov. 2, 2023

(54) SYSTEMS AND METHODS OF UPDATING FLIGHT PLANS BASED ON REGULATED AREAS

(71) Applicant: THE BOEING COMPANY, Arlington, VA (US)

(72) Inventors: Pablo Costas Alvarez, Mjadahonda (ES); Javier Lopez Leones, Majadahonda (ES); Nicolas Pena Ortiz, Seville (ES); Alejandro Guemes Jimenez, Getafe (EH)

(21) Appl. No.: 18/301,457

(22) Filed: Apr. 17, 2023

(30) Foreign Application Priority Data
Apr. 27, 2022 (EP) 22382402.0

(51) Int. Cl. G08G 5/00

(52) U.S. Cl. CPC G08G 5/0039; G08G 5/0073; G08G 5/0013

(57) ABSTRACT

A device includes one or more processors configured to receive an indication that a geographical area is expected to be regulated during a particular time window. The one or more processors are also configured to perform a comparison of the geographical area to route segments of a filed flight plan of a flight of an aircraft. The one or more processors are further configured to, based on determining that a route segment of the filed flight plan traverses at least a portion of the geographical area during the particular time window, determine alternate flight plans that do not traverse the geographical area during the particular time window. The one or more processors are also configured to select one of the alternate flight plans that satisfies a selection criterion as an updated flight plan of the flight, and to send the updated flight plan to a second device.

### CROSS REFERENCE TO RELATED APPLICATIONS

The present application claims priority from European Patent Application No. EP22382402.0, filed on Apr. 27, 2022 with the Spanish Receiving Office of the European Patent Office and entitled “SYSTEMS AND METHODS OF UPDATING FLIGHT PLANS BASED ON REGULATED AREAS,” which is incorporated herein by reference in its entirety.

### FIELD OF THE DISCLOSURE

The present disclosure is generally related to updating flight plans based on regulated areas.

### BACKGROUND

A number of aircraft that air traffic control can safely handle is based on available staffing, equipment, etc. Aircraft traffic is typically regulated (e.g., limited) so that the number of aircraft within an area controlled by any air traffic control area does not exceed operational safety requirements. There can be other reasons, such as weather, for regulated (e.g., limited) aircraft traffic in a geographical area. Aircraft that are expected to be within a geographical area that is regulated (e.g., limited traffic due to some specified constraints) during a time window are often delayed at departure to avoid the regulated geographical area during the time window. The departure delays can cause costly reactionary delays of subsequent flights of the aircraft, another aircraft that is intended to be staffed by one or more of the crew members of the delayed flight, and so on. Passengers who miss connecting flights have to be compensated and placed on other flights to reach their intended destinations.

### SUMMARY

In a particular implementation, a device includes one or more processors configured to receive an indication that a geographical area is expected to be regulated during a particular time window. The one or more processors are also configured to perform a comparison of the geographical area to route segments of a filed flight plan of a flight of an aircraft. The one or more processors are further configured to, based on determining that a route segment of the filed flight plan traverses at least a portion of the geographical area during the particular time window, determine alternate flight plans that do not traverse the geographical area during the particular time window. The one or more processors are also configured to select one of the alternate flight plans that satisfies a selection criterion as an updated flight plan of the flight, and to send the updated flight plan to a second device.

In another particular implementation, a method includes receiving, at a first device, an indication that a geographical area is expected to be regulated during a particular time window. The method also includes performing, at the first device, a comparison of the geographical area to route segments of a filed flight plan of a flight of an aircraft. The method further includes, based on determining that a route segment of the filed flight plan traverses at least a portion of the geographical area during the particular time window, determine alternate flight plans that do not traverse the geographical area during the particular time window. The method further includes selecting, at the first device, one of the alternate flight plans that satisfies a selection criterion as an updated flight plan of the flight. The method also includes sending the updated flight plan from the first device to a second device.

In another particular implementation, a non-transitory computer readable medium stores instructions that, when executed by one or more processors, cause the one or more processors to receive an indication that a geographical area is expected to be regulated during a particular time window. The instructions, when executed by the one or more processors, also cause the one or more processors to perform a comparison of the geographical area to route segments of a filed flight plan of a flight of an aircraft. The instructions, when executed by the one or more processors, further cause the one or more processors to, based on determining that a route segment of the filed flight plan traverses at least a portion of the geographical area during the particular time window, determine alternate flight plans that do not traverse the geographical area during the particular time window. The instructions, when executed by the one or more processors, also cause the one or more processors to select one of the alternate flight plans that satisfies a selection criterion as an updated flight plan of the flight. The instructions, when executed by the one or more processors, further cause the one or more processors to send the updated flight plan to a second device

The features, functions, and advantages described herein can be achieved independently in various implementations or may be combined in yet other implementations, further details of which can be found with reference to the following description and drawings.

### BRIEF DESCRIPTION OF THE DRAWINGS

FIG. 1A is a diagram that illustrates a system configured to update flight plans based on regulated areas.

FIG. 1B is a diagram of illustrative examples of an original flight plan and an updated flight plan generated by the system of FIG. 1A.

FIG. 2 is a diagram of illustrative examples of data used or generated by the system of FIG. 1A.

FIG. 3 is a diagram of a particular implementation of a flight plan analyzer of the system of FIG. 1A.

FIG. 4 is a diagram of a particular implementation of a regulated route detector of the flight plan analyzer of FIG. 3.

FIG. 5A is a diagram of a particular implementation of an alternate flight plan generator of the flight plan analyzer of FIG. 3.

FIG. 5B is a diagram of another implementation of an alternate flight plan generator of the flight plan analyzer of FIG. 3.

FIG. 6 is a diagram that illustrates a flow chart of an example of a method of updating flight plans based on regulated areas.

FIG. 7 is a flow diagram illustrating a life cycle of a vehicle that includes the aspects of the system of FIG. 1A.

FIG. 8 is a diagram illustrating a particular example of a vehicle that includes the aspects of the system of FIG. 1A where the vehicle corresponds to an aircraft.

FIG. 9 is a block diagram of a computing environment including a computing device configured to support aspects of computer-implemented methods and computer-executable program instructions (or code) according to the present disclosure.

### DETAILED DESCRIPTION

Aspects disclosed herein present systems and methods of updating flight plans based on regulated areas. Aircraft traffic is regulated (e.g., limited due to some specified constraints) to limit the number of aircraft in a geographical area to below a particular threshold during a time window. Aircraft that are expected to be within a geographical area that is regulated during a time window are often delayed at departure to avoid the geographical area during the time window. The departure delays can cause costly reactionary flight delays, where subsequent flights are delayed or canceled. Passengers who miss connecting flights have to be compensated and placed on other flights to reach their intended destinations. When an aircraft crew member is on a delayed flight, a subsequent flight of another aircraft that is to be staffed by the aircraft crew member has to be delayed or restaffed.

According to a particular aspect, a flight plan analyzer has access to one or more filed flight plans. For example, a filed flight plan indicates that a flight from a departure airport to an arrival airport has a planned departure time and a planned arrival time. The filed flight plan also indicates a planned route from the arrival airport, via one or more planned way points, to the departure airport.

The flight plan analyzer receives an indication (e.g., from an aviation authority) that a geographical area is expected to be regulated during a particular time window and that affected flights are expected to have an expected departure delay (e.g., 1 hour). The flight plan analyzer, responsive to receiving the indication, determines whether a filed flight plan of a flight includes a route segment that traverses at least a portion of the geographical area during the particular time window. The flight plan analyzer, in response to identifying such a filed flight plan, determines an expected departure time (e.g., 2 PM) based on the planned departure time (e.g., 1 PM) and the expected departure delay (e.g., 1 hour). Similarly, the flight plan analyzer determines an expected arrival time (e.g., 6 PM) based on the expected departure time (e.g., 2 PM) and an expected flight time (e.g., 4 hours) of the planned route.

The flight plan analyzer determines alternate flight plans from the departure airport to the arrival airport. Each of the alternate flight plans has a departure time between the planned departure time (e.g., 1 PM) and the expected departure time (e.g., 2 PM) and does not traverse the geographical area during the particular time window. As an example, a first alternate flight plan can include a pre-configured route from the departure airport to the arrival airport. As another example, the flight plan analyzer can generate a route of a second alternate flight plan by selecting one or more way points based on the arrival airport, the departure airport, the regulated geographical area, the expected departure delay (e.g., 1 hour), or a combination thereof.

The flight plan analyzer selects one of the alternate flight plans based on a selection criterion (e.g., fuel cost, weather conditions, arrival time, etc.) as an updated flight plan of the flight. The flight plan analyzer sends the updated flight plan to another device. For example, the flight plan analyzer files the updated flight plan with an airline, an airport, an aviation authority, or a combination thereof. The flight plan analyzer can thus reduce (e.g., eliminate) delays and costs by updating the flight plan to include an alternate route that avoids a regulated geographical area.

The figures and the following description illustrate specific exemplary embodiments. It will be appreciated that those skilled in the art will be able to devise various arrangements that, although not explicitly described or shown herein, embody the principles described herein and are included within the scope of the claims that follow this description. Furthermore, any examples described herein are intended to aid in understanding the principles of the disclosure and are to be construed as being without limitation. As a result, this disclosure is not limited to the specific embodiments or examples described below, but by the claims and their equivalents.

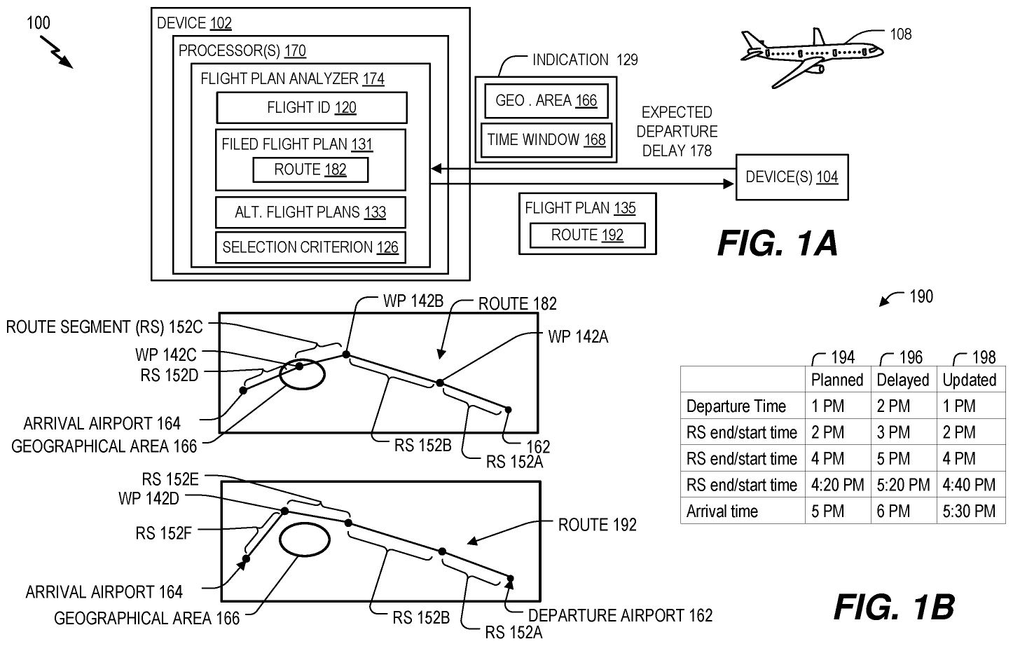

Particular implementations are described herein with reference to the drawings. In the description, common features are designated by common reference numbers throughout the drawings. In some drawings, multiple instances of a particular type of feature are used. Although these features are physically and/or logically distinct, the same reference number is used for each, and the different instances are distinguished by addition of a letter to the reference number. When the features as a group or a type are referred to herein (e.g., when no particular one of the features is being referenced), the reference number is used without a distinguishing letter. However, when one particular feature of multiple features of the same type is referred to herein, the reference number is used with the distinguishing letter. For example, referring to FIG. 1B, multiple route segments are illustrated and associated with reference numbers 152A and 152B. When referring to a particular one of these route segments, such as the route segment 152A, the distinguishing letter “A” is used. However, when referring to any arbitrary one of these route segments or to these route segments as a group, the reference number 152 is used without a distinguishing letter.

As used herein, various terminology is used for the purpose of describing particular implementations only and is not intended to be limiting. For example, the singular forms “a,” “an,” and “the” are intended to include the plural forms as well, unless the context clearly indicates otherwise. Further, some features described herein are singular in some implementations and plural in other implementations. To illustrate, FIG. 1A depicts a system 100 including one or more processors (“processor(s)” 170 in FIG. 1A), which indicates that in some implementations the system 100 includes a single processor 170 and in other implementations the system 100 includes multiple processors 170. For ease of reference herein, such features are generally introduced as “one or more” features, and are subsequently referred to in the singular unless aspects related to multiple of the features are being described.

The terms “comprise,” “comprises,” and “comprising” are used interchangeably with “include,” “includes,” or “including.” Additionally, the term “wherein” is used interchangeably with the term “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

As used herein, “generating,” “calculating,” “using,” “selecting,” “accessing,” and “determining” are interchangeable unless context indicates otherwise. For example, “generating,” “calculating,” or “determining” a parameter (or a signal) can refer to actively generating, calculating, or determining the parameter (or the signal) or can refer to using, selecting, or accessing the parameter (or signal) that is already generated, such as by another component or device. As used herein, “coupled” can include “communicatively coupled,” “electrically coupled,” or “physically coupled,” and can also (or alternatively) include any combinations thereof. Two devices (or components) can be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled can be included in the same device or in different devices and can be connected via electronics, one or more connectors, or inductive coupling, as illustrative, non-limiting examples. In some implementations, two devices (or components) that are communicatively coupled, such as in electrical communication, can send and receive electrical signals (digital signals or analog signals) directly or indirectly, such as via one or more wires, buses, networks, etc. As used herein, “directly coupled” is used to describe two devices that are coupled (e.g., communicatively coupled, electrically coupled, or physically coupled) without intervening components.

FIG. 1A depicts an example of a system 100 that is configured to update flight plans based on regulated areas. The system 100 includes a device 102 coupled, via one or more networks, to one or more devices 104. For example, the one or more networks can include one or more wired networks, one or more wireless networks, or a combination thereof. Two or more of the device 102, the one or more devices 104, or a combination thereof, can be co-located or geographically distributed from each other.

The device 102 includes one or more processors 170 that include a flight plan analyzer 174. The one or more processors 170 can be implemented as a single processor or as multiple processors, such as in a multi-core configuration, a multi-processor configuration, a distributed computing configuration, a cloud computing configuration, or any combination thereof. In some implementations, one or more portions of the flight plan analyzer 174 are implemented by the one or more processors 170 using dedicated hardware, firmware, or a combination thereof.

The flight plan analyzer 174 is configured to receive an indication 129 of a geographical area 166 (e.g., a regulated geographical area) from at least one of the one or more devices 104. The indication 129 indicates that the geographical area 166 is expected to be regulated during a time window 168 (e.g., 3 PM-4:30 PM). The flight plan analyzer 174 is configured to access filed flight plans of flights of one or more aircraft. For example, the flight plan analyzer 174 is configured to access a filed flight plan 131 of a flight of an aircraft 108. The filed flight plan 131 indicates a route 182 (e.g., a planned route) from a departure airport 162 to an arrival airport 164. In some aspects, the device 102 is integrated into a ground-based flight control system of an airline. In these aspects, the flight plan analyzer 174 has access to filed flight plans of aircraft of the airline.

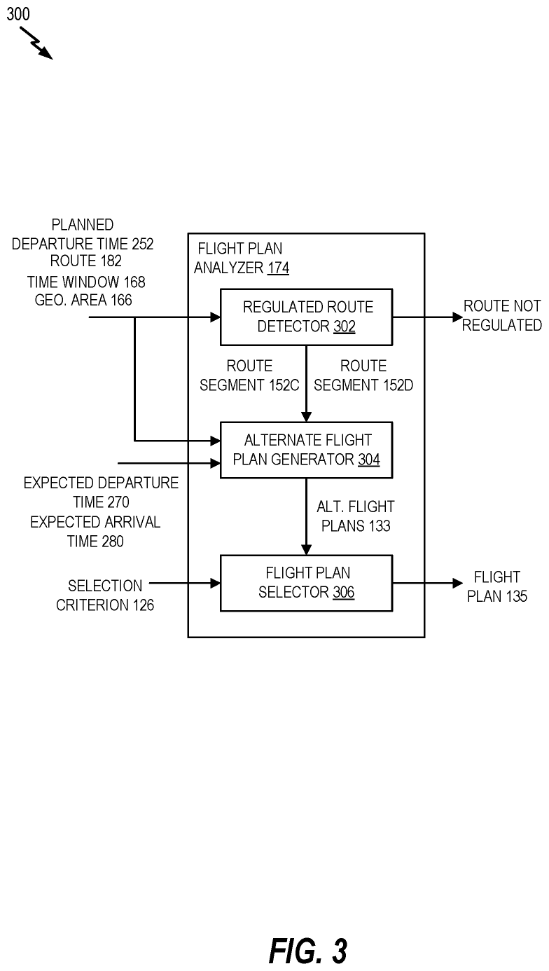

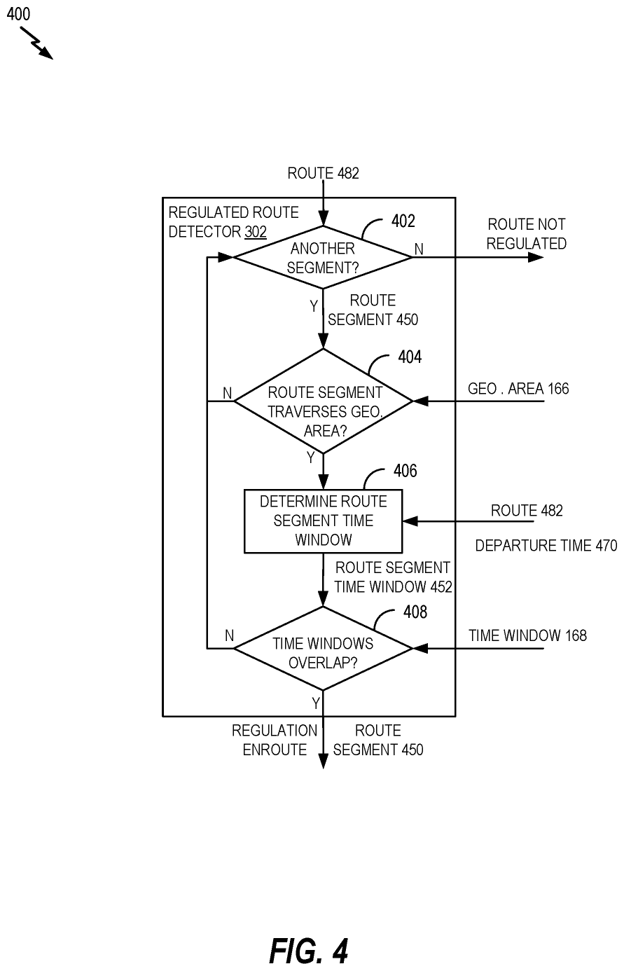

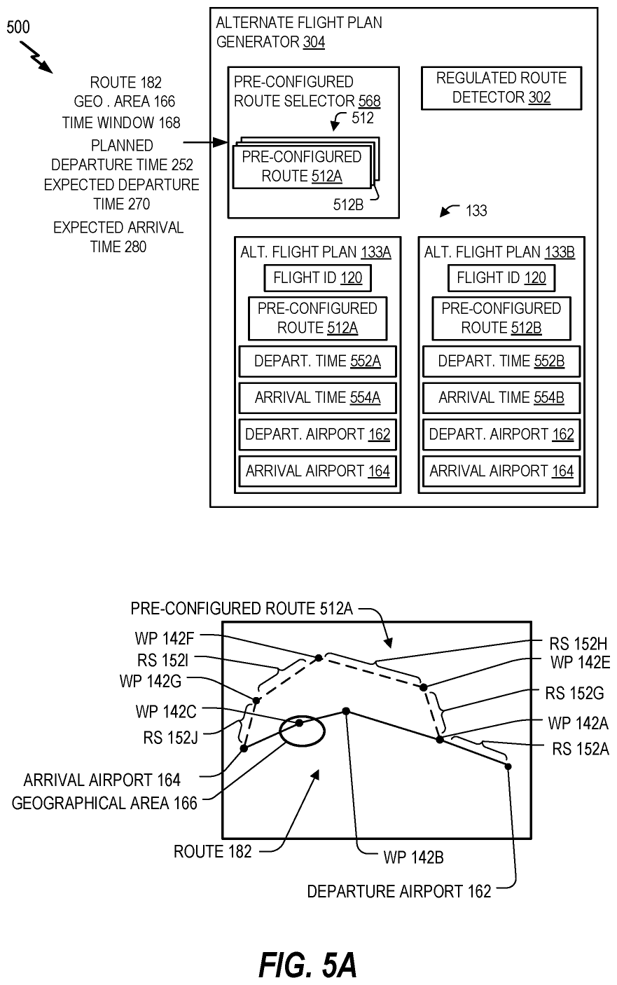

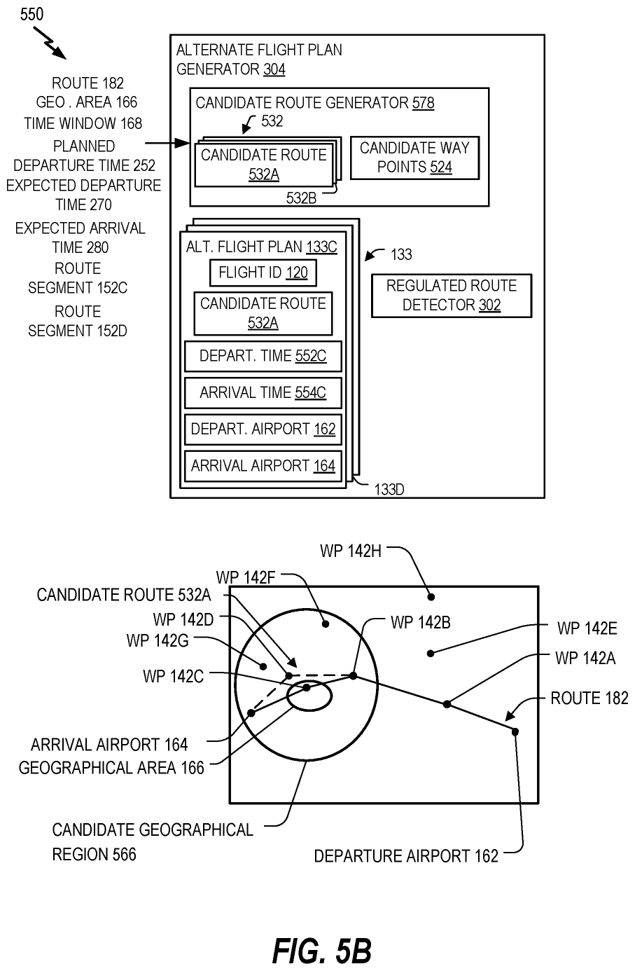

The flight plan analyzer 174 is configured to, responsive to receiving the indication 129, determine whether the route 182 includes any regulated route segments (e.g., expected to have limited traffic due to some specific constraints), as further described with reference to FIGS. 3 and 4. The flight plan analyzer 174 is configured, in response to determining that the route 182 includes a regulated route segment, generate alternate flight plans 133 that avoid the geographical area 166 during the time window 168, as further described with reference to FIGS. 3, 5A, and 5B. The flight plan analyzer 174 is configured to select, based on a selection criterion 126, one of the alternate flight plans 133, as a flight plan 135 (e.g., an updated flight plan). The flight plan analyzer 174 is configured to provide the flight plan 135 to at least one of the one or more devices 104, the aircraft 108, or both.

During operation, the flight plan analyzer 174 has access to the filed flight plan 131 of a flight (e.g., indicated by a flight identifier 120) of the aircraft 108. In a particular aspect, the aircraft 108 is piloted, remote-controlled, autonomous, partially autonomous, or a combination thereof. In some examples, the aircraft 108 includes a commercial aircraft, a passenger aircraft, a cargo aircraft, a military aircraft, an unmanned aerial vehicle (UAV), an airplane, a helicopter, a spacecraft, another type of aircraft, or a combination thereof.

An example of the route 182 (e.g., a planned route) of the filed flight plan 131 is shown in FIG. 1B. The route 182 includes a plurality of route segments 152, such as a route segment (RS) 152A from the departure airport 162 to a way point (WP) 142A, a route segment 152B from the way point 142A to a way point 142B, a route segment 152C from the way point 142B to a way point 142C, and a route segment 152D from the way point 142C to the arrival airport 164. The route 182 including 4 route segments is provided as an illustrative example. In other examples, the route 182 can include more than 4 or fewer than 4 route segments.

A table 190 of illustrative examples of route segment time windows is shown. For example, a column 194 provides examples of route segment start times and route segment end times of the route segments 152 of the route 182 corresponding to the filed flight plan 131. To illustrate, with a planned departure time of 1 PM and an expected duration of 1 hour of the route segment 152A, a route segment time window of the route segment 152A is from 1 PM to 2 PM. With an expected duration of 2 hours of the route segment 152B, a route segment time window of the route segment 152B is from 2 PM to 4 PM. With an expected duration of 20 minutes of the route segment 152C, a route segment time window of the route segment 152C is from 4 PM to 4:20 PM. With an expected duration of 40 minutes of the route segment 152D, a route segment time window of the route segment 152D is from 4:20 PM to 5 PM. It should be understood that particular times and durations associated with the route segments 152 of the route 182 are provided for ease of explanation, in other examples the route segments 152 can be associated with various other times and durations.

Returning to FIG. 1A, the flight plan analyzer 174 receives the indication 129 from at least one of the one or more devices 104. For example, the indication 129 is based on a notification from an aviation authority. The indication 129 indicates that a geographical area 166 is expected to be regulated during a time window 168 (e.g., 3 PM-4:30 PM). As used herein, “regulated” refers to restricted entry. For example, an aviation authority is expected to restrict entry by aircraft in the geographical area 166 during the time window 168. In some examples, restricting entry corresponds to limiting entry to no more than a threshold count (e.g., an integer greater than or equal to zero) of aircraft in the geographical area 166 during the time window 168. The geographical area 166 can have restricted entry for various reasons, such as operational safety of aircraft control, weather conditions, conflict regions, safety alerts, etc. In some aspects, the threshold count is based on available aircraft control staff, available aircraft control equipment, weather conditions, a user input, a configuration setting, etc. In some implementations, the indication 129 is based on predicted aircraft traffic, predicted weather conditions, ground staffing, ground equipment malfunction, military operations, military training, another type of predicted capacity alteration, or any combination thereof.

The flight plan analyzer 174 also receives data indicating an expected departure delay 178 (e.g., 1 hour) from at least one of the one or more devices 104. In some aspects, the flight plan analyzer 174 receives the expected departure delay 178 concurrently with receiving the indication 129 from the same device. In other aspects, the flight plan analyzer 174 receives the indication 129 from a first device and receives the expected departure delay 178 from a second device that is distinct from the first device.

The expected departure delay 178 indicates an amount of time that flight departure is expected to be delayed for aircraft to avoid the geographical area 166 during the time window 168. In a first implementation, the expected departure delay 178 is specific to the aircraft 108. In a second implementation, the expected departure delay 178 (e.g., the same delay) is expected to be applied to any aircraft that is expected to be within the geographical area 166 during the time window 168.

The flight plan analyzer 174 determines whether routes of any filed flight plans include a regulated route segment. For example, in the first implementation, the flight plan analyzer 174, in response to receiving the expected departure delay 178 concurrently with the indication 129 and determining that the expected departure delay 178 is to be applied to the flight of the aircraft 108, determines that the route 182 of the filed flight plan 131 of the aircraft 108 includes at least one regulated route segment. In other examples, the flight plan analyzer 174 performs a comparison of the geographical area 166 to route segments of one or more filed flight plans to determine if any filed flight plans include a regulated route segment. For example, the flight plan analyzer 174 determines whether the route 182 includes a regulated route segment, as further described with reference to FIG. 4. As used herein, a “regulated route segment” refers to a route segment that is expected to traverse at least a portion of the geographical area 166 during the time window 168.

In FIG. 1B, the route segment 152C and the route segment 152D traverse the geographical area 166. The flight plan analyzer 174 determines that the route segment 152C and the route segment 152D of the route 182 correspond to regulated route segments in response to determining that the route segment 152C and the route segment 152D are expected to traverse at least a portion of the geographical area 166 during the time window 168 (e.g., 3 PM-4:30 PM). For example, the route segment 152C and the route segment 152D are expected to traverse at least a portion of the geographical area 166 during a first route segment time window (e.g., 4 PM and 4:20 PM) and a second route segment time window (e.g., 4:20 PM to 5 PM), respectively, that each at least partially overlaps the time window 168 (e.g., 3 PM-4:30 PM).

A column 196 of the table 190 provides examples of route segment start times and route segment end times of the route segments 152 of the route 182 corresponding to the expected departure delay 178. To illustrate, with the expected departure delay 178 (e.g., 1 hour), each of the route segment time windows is delayed by an hour, resulting in a delayed arrival time (e.g., 6 PM).

Returning to FIG. 1A, the flight plan analyzer 174 determines alternate flight plans 133 in response to determining that the route 182 includes a regulated route segment, as further described with reference to FIGS. 5A-5B. Each of the alternate flight plans 133 is associated with a departure delay that is less than the expected departure delay 178 and does not traverse the geographical area 166 during the time window 168. In some examples, an alternate flight plan can include a pre-configured route between the departure airport 162 and the arrival airport 164, as further described with reference to FIG. 5A. In some examples, the flight plan analyzer 174 selects one or more candidate way points based on the departure airport 162, the arrival airport 164, and the expected departure delay 178, and an alternate flight plan includes a route that is based on the one or more candidate way points, as further described with reference to FIG. 5B. The flight plan analyzer 174 selects one of the alternate flight plans 133 that satisfies the selection criterion 126 as the flight plan 135 (e.g., an updated flight plan) of the flight (e.g., indicated by the flight identifier 120), as further described with reference to FIG. 3.

The flight plan 135 includes a route 192 between the departure airport 162 and the arrival airport 164. An example of the route 192 of the flight plan 135 (e.g., the updated flight plan) is shown in FIG. 1B. The route 192 includes a plurality of route segments 152, such as the route segment 152A from the departure airport 162 to the way point 142A, the route segment 152B from the way point 142A to the way point 142B, a route segment 152E from the way point 142B to a way point 142D, and a route segment 152F from the way point 142D to the arrival airport 164.

A column 198 of the table 190 provides examples of route segment start times and route segment end times of the route segments 152 of the route 192 of the flight plan 135 (e.g., the updated flight plan). To illustrate, with a planned departure time of 1 PM and an expected duration of 1 hour of the route segment 152A, the route segment time window of the route segment 152A is unchanged (e.g., from 1 PM to 2 PM). With the expected duration of 2 hours of the route segment 152B, the route segment time window of the route segment 152B is unchanged (e.g., from 2 PM to 4 PM). With an expected duration of 40 minutes of the route segment 152E, a route segment time window of the route segment 152E is from 4 PM to 4:40 PM. With an expected duration of 50 minutes of the route segment 152F, a route segment time window of the route segment 152F is from 4:40 PM to 5:30 PM. It should be understood that particular times and durations associated with the route segments 152 of the route 192 are provided for ease of explanation, in other examples the route segments 152 can be associated with various other times and durations. In some examples, the flight plan 135 is associated with a planned arrival time (e.g., 5:30 PM) that is subsequent to the planned arrival time (e.g., 5 PM) of the filed flight plan 131 and is earlier than the expected arrival time (e.g., 6 PM) resulting from the expected departure delay 178. The earlier arrival time (e.g., 5:30 PM instead of 6 PM) can reduce reactionary delays and missed connections.

The route 192 including 4 route segments is provided as an illustrative example. In other examples, the route 192 can include more than 4 or fewer than 4 route segments. The route 192 including the same count of route segments as the route 182 is provided as an illustrative example. In other examples, the route 192 can include fewer route segments or more route segments than the route 182. The route segment 152C and the route segment 152D are not included in the route 192. The route 192 does not include any regulated route segments. The route 192 avoiding the geographical area 166 entirely is shown as an illustrative example. In some examples, the route 192 traverses the geographical area 166 outside (e.g., before or after) the time window 168 (e.g., 3 PM-4:30 PM).

The flight plan analyzer 174 provides the flight plan 135 as an updated flight plan of the flight (e.g., indicated by the flight identifier 120) of the aircraft 108 to at least one of the one or more devices 104, the aircraft 108, or a combination thereof. In a particular aspect, the at least one of the one or more devices 104 includes a flight plan approval device, an aviation authority device, a ground personnel device, or a combination thereof. For example, flight plan analyzer 174 files the flight plan 135 with an aviation authority, an airport, an airline, or a combination thereof. To illustrate, the flight plan analyzer 174 sends the flight plan 135 to the at least one of the one or more devices 104, the aircraft 108, or a combination thereof, prior to the flight (e.g., indicated by the flight identifier 120).

The system 100 thus enables updating a filed flight plan to reduce a departure delay associated with avoiding a regulated geographical area (e.g., the geographical area 166 during the time window 168). The reduction in departure delay can reduce (e.g., eliminate) an arrival delay, thereby resulting in reduced reactionary flight delays and associated costs.

Although FIG. 1A depicts the device 102 as external to the aircraft 108, in some implementations the device 102 is integrated in the aircraft 108. The flight plan analyzer 174 generating an updated flight plan for a single flight of the aircraft 108 is provided as an illustrative example. In other examples, the flight plan analyzer 174 can generate updated flight plans for multiple flights of one or more aircraft. In some implementations, the flight plan analyzer 174 can be represented in hardware, such as via an application-specific integrated circuit (ASIC) or a field-programmable gate array (FPGA), or the operations described with reference to the elements may be performed by a processor executing computer-readable instructions.

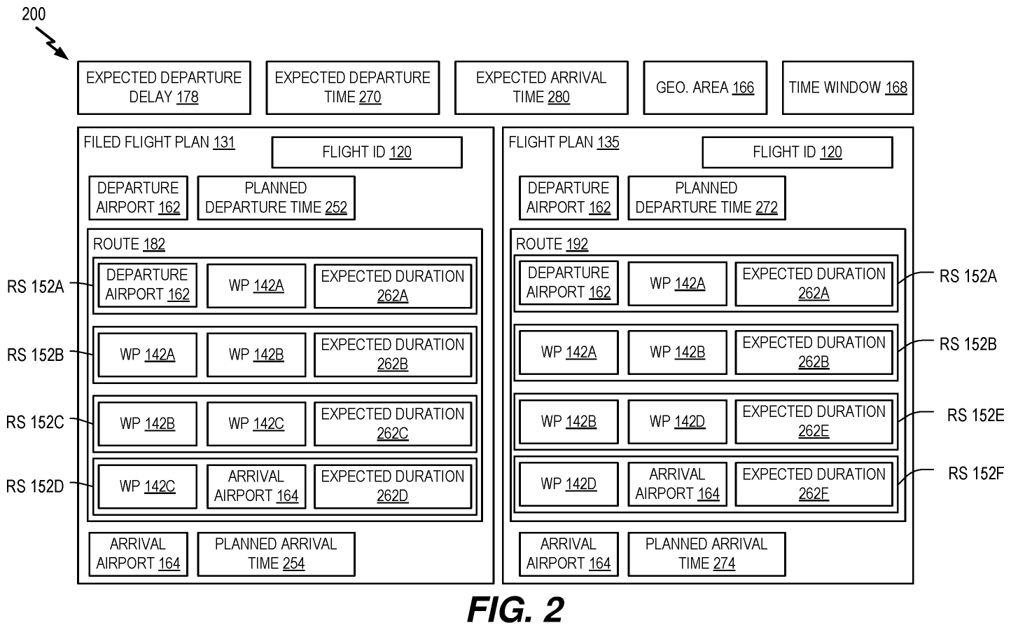

Referring to FIG. 2, a diagram of illustrative examples of data 200 used or generated by the system 100 of FIG. 1A is shown. For example, the data 200 indicates the expected departure delay 178 (e.g., 1 hour), the geographical area 166, the time window 168 (e.g., 3 PM-4:30 PM), and the filed flight plan 131.

The filed flight plan 131 indicates the flight identifier 120 of a flight of the aircraft 108 of FIG. 1A. The filed flight plan 131 indicates a planned departure time 252 (e.g., 1 PM) from the departure airport 162 and a planned arrival time 254 (e.g., 5 PM) at the arrival airport 164. The filed flight plan 131 indicates route segments 152 of the route 182. For example, the filed flight plan 131 indicates the route segment 152A, the route segment 152B, the route segment 152C, and the route segment 152D from the departure airport 162 to the way point 142A, the way point 142A to the way point 142B, the way point 142B to the way point 142C, and the way point 142C to the arrival airport 164, respectively.

In some implementations, the filed flight plan 131 indicates expected durations of the route segments 152 of the route 182. For example, the filed flight plan 131 indicates an expected duration 262A (e.g., 1 hour), an expected duration 262B (e.g., 2 hours), an expected duration 262C (e.g., 20 minutes), and an expected duration 262D (e.g., 40 minutes) of the route segment 152A, the route segment 152B, the route segment 152C, and the route segment 152D, respectively.

The flight plan analyzer 174 of FIG. 1A, in response to receiving the indication 129, determines an expected departure time 270 (e.g., 2 PM) based on the planned departure time 252 (e.g., 1 PM) and the expected departure delay 178 (e.g., 1 hour). For example, the expected departure time 270 is a sum of the planned departure time 252 and the expected departure delay 178. Similarly, the flight plan analyzer 174, in response to receiving the indication 129, determines an expected arrival time 280 (e.g., 6 PM) based on the planned arrival time 254 (e.g., 5 PM) and the expected departure delay 178 (e.g., 1 hour). The flight plan analyzer 174 generates the flight plan 135, as further described with reference to FIG. 3.

The flight plan 135 indicates the flight identifier 120 of the flight of the aircraft 108 of FIG. 1A. The flight plan 135 indicates a planned departure time 272 (e.g., 1 PM) from the departure airport 162 and a planned arrival time 274 (e.g., 5:30 PM) at the arrival airport 164. The flight plan 135 indicates route segments 152 of the route 192. For example, the flight plan 135 indicates the route segment 152A, the route segment 152B, the route segment 152E, and the route segment 152F from the departure airport 162 to the way point 142A, the way point 142A to the way point 142B, the way point 142B to the way point 142D, and the way point 142D to the arrival airport 164, respectively.

In some implementations, the flight plan 135 indicates expected durations of the route segments 152 of the route 192. For example, the filed flight plan 131 indicates the expected duration 262A (e.g., 1 hour), the expected duration 262B (e.g., 2 hours), an expected duration 262E (e.g., 40 minutes), and an expected duration 262F (e.g., 50 minutes) of the route segment 152A, the route segment 152B, the route segment 152E, and the route segment 152F, respectively.

In some implementations, the filed flight plan 131, the flight plan 135, or both, can include one or more different data elements than shown in FIG. 2. In some examples, the filed flight plan 131, the flight plan 135, or both, can include fewer data elements or more data elements than shown in FIG. 2.

Referring to FIG. 3, a diagram 300 of a particular implementation of the flight plan analyzer 174 is shown. The flight plan analyzer 174 includes a regulated route detector 302 coupled via an alternate flight plan generator 304 to a flight plan selector 306.

The regulated route detector 302 is configured to determine, based on the geographical area 166, the time window 168, and the planned departure time 252, whether the route 182 includes any regulated route segments, as further described with reference to FIG. 4. For example, the regulated route detector 302, in response to determining that the route 182 does not include any regulated route segments, generates an output indicating that the route 182 is not regulated. Alternatively, the regulated route detector 302, in response to determining that the route 182 includes one or more regulated route segments (e.g., the route segment 152C and the route segment 152D), provides an output to the alternate flight plan generator 304 indicating the one or more regulated route segments.

The alternate flight plan generator 304 is configured to, in response to determining that the route 182 includes the one or more regulated route segments (e.g., the route segment 152C and the route segment 152D), determine the alternate flight plans 133 based on the geographical area 166, the time window 168, the planned departure time 252, the expected departure time 270, or a combination thereof, as further described with reference to FIGS. 5A-5B. In some aspects, one or more of the alternate flight plans 133 has a corresponding departure time that is earlier than the expected departure time 270. In some aspects, one or more of the alternate flight plans 133 has a corresponding departure time that is equal to the expected departure time 270. The alternate flight plan generator 304 provides the alternate flight plans 133 to the flight plan selector 306.

The flight plan selector 306 is configured to select one of the alternate flight plans 133 that satisfies the selection criterion 126 as the flight plan 135. In some aspects, the selection criterion 126 is based on a comparison of arrival times, fuel costs, environmental costs, reactionary costs, or a combination thereof, of the alternate flight plans 133, the filed flight plan 131, or a combination thereof. In some implementations, the flight plan selector 306 determines an expected cost (e.g., an expected fuel cost, an expected environmental cost, an expected reactionary cost, or a combination thereof) associated with the expected departure delay 178 of the filed flight plan 131. The flight plan selector 306 determines an alternate cost (e.g., an alternate fuel cost, an alternate environmental cost, an alternate reactionary cost, or a combination thereof) of each of the alternate flight plans 133. The flight plan selector 306 determines a cost saving associated with each of the alternate flight plans 133 based on a comparison of a corresponding alternate cost and the expected cost. In some aspects, the flight plan selector 306 determines that particular alternate flight plan of the alternate flight plans 133 with a highest cost saving satisfies the selection criterion 126 and selects the particular alternate flight plan as the flight plan 135. In some implementations, the selection criterion 126 is based on user input, a configuration setting, or both.

Referring to FIG. 4, a diagram 400 of a particular implementation of the regulated route detector 302 is shown. The regulated route detector 302 analyzes route segments of a route 482 (e.g., the route 182 of FIG. 1A) to determine whether the route segments traverse at least a portion of the geographical area 166 during the time window 168.

In a particular aspect, the regulated route detector 302 determines whether the route 482 includes another route segment, at 402. The regulated route detector 302, in response to determining that the route 482 does not include another route segment 450, outputs an indication that the route 482 is not regulated (e.g., does not include any regulated route segments). Alternatively, the regulated route detector 302, in response to determining that the route 482 includes another route segment 450, determines whether the route segment 450 traverses at least a portion of the geographical area 166, at 404. The regulated route detector 302, in response to determining that the route 482 includes the route segment 450 and that the route segment 450 (e.g., the route segment 152A or the route segment 152B) does not traverse the geographical area 166, returns to the determination at 402.

Alternatively, the regulated route detector 302, in response to determining that the route segment 450 (e.g., the route segment 152C) traverses at least a portion of the geographical area 166, determines a route segment time window 452 of the route segment 450, at 406. For example, the regulated route detector 302 determines that the route segment time window 452 is from a route segment start time (e.g., 4 PM) to a route segment end time (e.g., 4:20 PM). The regulated route detector 302 determines the route segment start time based on a departure time 470 (e.g., the expected departure time 270 of FIG. 2) and the expected duration of one or more previous route segments (e.g., the route segment 152A and the route segment 152B). In an illustrative example, the first route segment time (e.g., 4 PM) is equal to a sum of the expected departure time 270 (e.g., 1 PM), the expected duration 262A (e.g., 1 hour), and the expected duration 262B (e.g., 2 hours). The route segment end time (e.g., 4:20 PM) is based on a sum of the first route segment time (e.g., 4 PM) and an expected duration (e.g., the expected duration 262C, such as 20 minutes) of the route segment 450.

The regulated route detector 302 determines whether the route segment time window 452 (e.g., 4 PM-4:20 PM) at least partially overlaps the time window 168 (e.g., 3 PM-4:30 PM), at 408. For example, the time window 168 is from a time window start (e.g., 3 PM) to a time window end (e.g., 4:30 PM). In some implementations, the regulated route detector 302 determines that the time window 168 at least partially overlaps the route segment time window 452 in response to determining that the route segment start time (e.g., 4 PM) is less than the time window end (e.g., 4:30 PM) and that the route segment end time (e.g., 4:20 PM) is greater than the time window start (e.g., 3:00 PM).

The regulated route detector 302, in response to determining that the route segment time window 452 does not at least partially overlap the time window 168, returns to the determination at 402. Alternatively, the regulated route detector 302, in response to determining that the route segment time window 452 (e.g., 4 PM-4:20 PM) at least partially overlaps the time window 168 (e.g., 3 PM-4:30 PM), outputs an indication that the route 482 is regulated (e.g., includes a regulated route segment) and an indication of the route segment 450 (e.g., the route segment 152C).

In this example, the regulated route detector 302 identifies an earliest regulated route segment (e.g., the route segment 152C) of the route 482. In other implementations, the regulated route detector 302 can generate a list of all regulated route segments (e.g., the route segment 152C and the route segment 152D) of the route 482. For example, the regulated route detector 302 can add the route segment 450 (e.g., the route segment 152C) to a list of regulated route segments and return to the determination at 402. The regulated route detector 302, in response to determining that the route 482 includes another route segment, proceeds to the determination at 404, as described above. Alternatively, the regulated route detector 302, in response to determining that all route segments of the route 482 have been processed and that the list of regulated route segments is empty, outputs the indication that the route 482 is not regulated. In another example, the regulated route detector 302, in response to determining that all route segments of the route 482 have been processed and that the list of regulated route segments is not empty, outputs the indication that the route 482 is regulated and outputs an indication of the regulated route segments (e.g., the route segment 152C and the route segment 152D) included in the list.

Referring to FIG. 5A, a diagram 500 of a particular implementation of an alternate flight plan generator 304 is shown. The alternate flight plan generator 304 includes a pre-configured route selector 568.

The pre-configured route selector 568 has access to the one or more pre-configured routes 512, such as a pre-configured route 512A, a pre-configured route 512B, one or more additional pre-configured routes, or a combination thereof. The pre-configured route selector 568 is configured to select at least one of one or more pre-configured routes 512 that is from the departure airport 162 to the arrival airport 164 and that avoids the geographical area 166 during the time window 168. The alternate flight plan generator 304 is configured to generate the alternate flight plans 133 based on the selected ones of the one or more pre-configured routes 512.

As an example, the pre-configured route selector 568 selects the pre-configured route 512A in response to determining that that the pre-configured route 512A is from the departure airport 162 to the arrival airport 164 and that the pre-configured route 512A does not traverse the geographical area 166. To illustrate, the pre-configured route 512A includes the route segment 152A from the departure airport 162 to the way point 142A, a route segment 152G from the way point 142A to a way point 142E, a route segment 152H from the way point 142E to a way point 142F, a route segment 1521 from the way point 142F to a way point 142G, and a route segment 152J from the way point 142G to the arrival airport 164.

The alternate flight plan generator 304 generates an alternate flight plan 133A based on the pre-configured route 512A. For example, the alternate flight plan 133A indicates the flight identifier 120, the departure airport 162, the arrival airport 164, the pre-configured route 512A, or a combination thereof. In a particular aspect, the alternate flight plan generator 304 determines a departure time 552A based on (e.g., the same as) the planned departure time 252. In some aspects, the alternate flight plan generator 304 determines an arrival time 554A based on the departure time 552A and expected durations of the route segments 152A and 152G-J of the pre-configured route 512A. The alternate flight plan generator 304 updates the alternate flight plan 133A to indicate the departure time 552A (e.g., a planned departure time) and the arrival time 554A (e.g., a planned arrival time).

In some implementations, the pre-configured route selector 568 selects the pre-configured route 512B in response to determining that the pre-configured route 512B is from the departure airport 162 to the arrival airport 164 and that, although the pre-configured route 512B traverses at least a portion of the geographical area 166, the pre-configured route 512B can avoid the geographical area 166 during the time window 168 with a particular departure time. For example, the pre-configured route selector 568 provides the pre-configured route 512B as the route 482 and a particular departure time (e.g., greater than or equal to the planned departure time 252) as the departure time 470 to the regulated route detector 302. The regulated route detector 302 performs operations described with reference to FIG. 4 to generate either a regulated indication that there is the pre-configured route 512B is regulated with the particular departure time or a not regulated indication that the pre-configured route 512B is not regulated with the particular departure time.

The pre-configured route selector 568, in response to receiving the regulated indication, determines a next departure time that is subsequent to a previous departure time provided to the regulated route detector 302. The pre-configured route selector 568 provides the next departure time as the departure time 470 and the pre-configured route 512B as the route 482 to the regulated route detector 302, and so on, until a not regulated indication is received, the next departure time is greater than or equal to the expected departure time 270, an arrival time based on the next departure time is greater than or equal to the expected arrival time 280, or a combination thereof.

The pre-configured route selector 568, in response to determining that a regulated indication has been received for each of the departure times for the pre-configured route 512B, determines that the pre-configured route 512B is not selected. Alternatively, the pre-configured route selector 568 selects the pre-configured route 512B in response to receiving the not regulated indication from the regulated route detector 302 for the pre-configured route 512B with a particular departure time. The alternate flight plan generator 304 generates an alternate flight plan 133B based on the pre-configured route 512B and designates the particular departure time as a departure time 552B (e.g., a planned departure time) of the alternate flight plan 133B.

The alternate flight plan 133B indicates the flight identifier 120, the departure airport 162, the arrival airport 164, the pre-configured route 512B, the departure time 552B, or a combination thereof. In some aspects, the alternate flight plan generator 304 determines an arrival time 554B based on the departure time 552B and expected durations of the route segments of the pre-configured route 512B. The alternate flight plan generator 304 updates the alternate flight plan 133B to indicate the arrival time 554B (e.g., a planned arrival time).

In an illustrative example, the pre-configured route 512B is the same as the route 182 and the departure time 552B (e.g., 1:30 PM) is greater than the planned departure time 252 (e.g., 1 PM) and less than the expected departure time 270 (e.g., 2 PM). In this example, a delay (e.g., 30 minutes) that is shorter than the expected departure delay 178 (e.g., 1 hour) can be used to avoid the geographical area 166 during the time window 168. In other examples, the pre-configured route 512B can be different from the route 182.

The alternate flight plans 133 including two alternate flight plans (e.g., the alternate flight plan 133A and the alternate flight plan 133B) based on pre-configured routes is provided as an illustrative example. In other examples, the alternate flight plans 133 can include fewer than two or more than two alternate flight plans that are based on pre-configured routes.

Referring to FIG. 5B, a diagram 550 of a particular implementation of an alternate flight plan generator 304 is shown. The alternate flight plan generator 304 includes a candidate route generator 578.

The candidate route generator 578 generates one or more candidate routes 532, such as a candidate route 532A, a candidate route 532B, one or more additional candidate routes, or a combination thereof. Each of the one or more candidate routes 532 is from the departure airport 162 to the arrival airport 164 and avoids the geographical area 166 during the time window 168.

In a particular aspect, the candidate route generator 578 receives an indication from the regulated route detector 302 of FIG. 3 that the route segment 152C and the route segment 152D correspond to regulated route segments of the route 182 based on the planned departure time 252. The candidate route generator 578 determines a candidate geographical region 566 based on the departure airport 162, the arrival airport 164, the route segment 152C, the route segment 152D, the expected departure delay 178, or a combination thereof. The candidate route generator 578 determines the candidate geographical region 566 for selecting way points that can be used to generate the one or more candidate routes 532. Reducing a count of way points that are analyzed to generate the one or more candidate routes 532 can conserve resources (e.g., time, computing cycles, or both).

In a particular implementation, the candidate geographical region 566 includes the departure airport 162 and the arrival airport 164. In another implementation, the candidate geographical region 566 includes a way point or airport included in each of one or more regulated route segments. For example, the candidate geographical region 566 includes the way point 142B and the way point 142C of the route segment 152C and the way point 142C and the arrival airport 164 of the route segment 152D.

In a particular aspect, one or more properties of the candidate geographical region 566 (e.g., a size of the candidate geographical region 566) is based on the expected departure delay 178. A smaller delay corresponds to a smaller size of the candidate geographical region 566. For example, if a way point 142H is associated with a travel time from the route 182 that is greater than a threshold time (e.g., that is based on the expected departure delay 178), a candidate route that includes the way point 142H is likely to have a more delayed arrival time than the expected arrival time 280 (e.g., with a departure time greater than or equal to the planned departure time 252). Limiting the size of the candidate geographical region 566 based on the expected departure delay 178 can conserve resources (e.g., time, computing cycles, or both) by limiting a count of way points to be analyzed while including way points that are expected to be useful in generating a candidate route that reduces reactionary delay costs (e.g., by having an arrival time that is earlier than the expected arrival time 280).

The candidate route generator 578 identifies a plurality of candidate way points (e.g., the way point 142D, the way point 142F, the way point 142G) that are included in the candidate geographical region 566 and are not included in the route 182. The candidate route generator 578 uses various path selection techniques to select candidate way points 524 from the plurality of candidate way points (e.g., the way point 142D, the way point 142F, and the way point 142G) and the way points (e.g., the way point 142A and the way point 142B) of the route 182 that are included in a route segment that is not regulated. For example, the candidate route generator 578 selects the candidate way points 524 including the way point 142A, the way point 142B, and the way point 142D.

The candidate route generator 578 generates the candidate route 532A from the departure airport 162 to the arrival airport 164 including the candidate way points 524 (e.g., the way point 142A, the way point 142B, and the way point 142D). To illustrate, the candidate route 532A includes the route segment 152A, the route segment 152B, the route segment 152E, and the route segment 152F.

The alternate flight plan generator 304 generates an alternate flight plan 133C based on the candidate route 532A. For example, the alternate flight plan 133C indicates the flight identifier 120, the departure airport 162, the arrival airport 164, the candidate route 532A, or a combination thereof. In a particular aspect, the alternate flight plan generator 304 determines a departure time 552C based on (e.g., the same as) the planned departure time 252. In some aspects, the alternate flight plan generator 304 determines an arrival time 554C based on the departure time 552C and expected durations of the route segments 152A, B, E, and F of the candidate route 532A. The alternate flight plan generator 304 updates the alternate flight plan 133C to indicate the departure time 552C (e.g., a planned departure time) and the arrival time 554C (e.g., a planned arrival time).

The candidate route generator 578 generating the candidate route 532A that does not traverse the geographical area 166 is provided as an illustrative example. In some examples, the candidate route generator 578 can generate a candidate route 532B that can pass through the geographical area 166 before or after the time window 168 with a particular departure. For example, the candidate route generator 578 provides the candidate route 532B as the route 482 and a particular departure time (e.g., greater than or equal to the planned departure time 252) as the departure time 470 to the regulated route detector 302. The regulated route detector 302 performs operations described with reference to FIG. 4 to generate either a regulated indication that the candidate route 532B is not regulated with the particular departure time or a not regulated indication that the candidate route 532B is not regulated with the particular departure time.

The candidate route generator 578, in response to receiving the regulated indication, determines a next departure time that is subsequent to a previous departure time provided to the regulated route detector 302. The candidate route generator 578 provides the next departure time as the departure time 470 and the candidate route 532B as the route 482 to the regulated route detector 302, and so on, until a not regulated indication is received, the next departure time is greater than or equal to the expected departure time 270, an arrival time based on the next departure time is greater than or equal to the expected arrival time 280, or a combination thereof.

The candidate route generator 578, in response to determining that a regulated indication has been received for each of the departure times for the candidate route 532B, determines that the candidate route 532B is not to be used to generate an alternate flight plan 133. Alternatively, the candidate route generator 578 determines that the candidate route 532B is to be used to generate an alternate flight plan 133D in response to receiving the not regulated indication from the regulated route detector 302 for the candidate route 532B with a particular departure time. The alternate flight plan generator 304 generates the alternate flight plan 133D based on the candidate route 532B and designates the particular departure time as a departure time (e.g., a planned departure time) of the alternate flight plan 133D.

The alternate flight plans 133 including two alternate flight plans (e.g., the alternate flight plan 133C and the alternate flight plan 133D) based on generated candidate routes is provided as an illustrative example. In other examples, the alternate flight plans 133 can include fewer than two or more than two alternate flight plans that are based on generated candidate routes. In some implementations, the alternate flight plan generator 304 can include the pre-configured route selector 568 and the candidate route generator 578. In such implementations, the alternate flight plans 133 can include one or more alternate flight plans based on pre-configured routes, one or more alternate flight plans based on generated candidate routes, or a combination thereof. For example, the alternate flight plans 133 can include the alternate flight plan 133A, the alternate flight plan 133B, the alternate flight plan 133C, the alternate flight plan 133D, one or more additional alternate flight plans, or a combination thereof.

The flight plan selector 306, based on determining that one of the alternate flight plans 133 (e.g., the alternate flight plan 133C) satisfies the selection criterion 126, selects the alternate flight plan 133C as the flight plan 135. For example, the flight plan selector 306 determines an expected cost of the filed flight plan 131 with the expected departure delay 178. To illustrate, the expected cost includes an expected fuel cost, an expected environmental cost, an expected reactionary cost, an expected weather related cost (e.g., passenger discomfort because of weather conditions or weather related flight risks), or a combination thereof. The flight plan selector 306 determines an alternate cost of each of the alternate flight plans 133. For example, the alternate cost includes an alternate fuel cost, an alternate environmental cost, an alternate reactionary cost, an alternate weather related cost, or a combination thereof. To illustrate, the flight plan selector 306 determines a first alternate cost, a second alternate cost, a third alternate cost, and a fourth alternate cost of the alternate flight plan 133A, the alternate flight plan 133B, the alternate flight plan 133C, and the alternate flight plan 133D.

In some implementations, the flight plan selector 306 determines that the alternate flight plan 133C satisfies the selection criterion 126 in response to determining that the third alternate cost of the alternate flight plan 133C is less than or equal to the expected cost, the first alternate cost, the second alternate cost, and the fourth alternate cost. The flight plan selector 306, in response to determining that the alternate flight plan 133C satisfies the selection criterion 126, selects the alternate flight plan 133C as the flight plan 135.

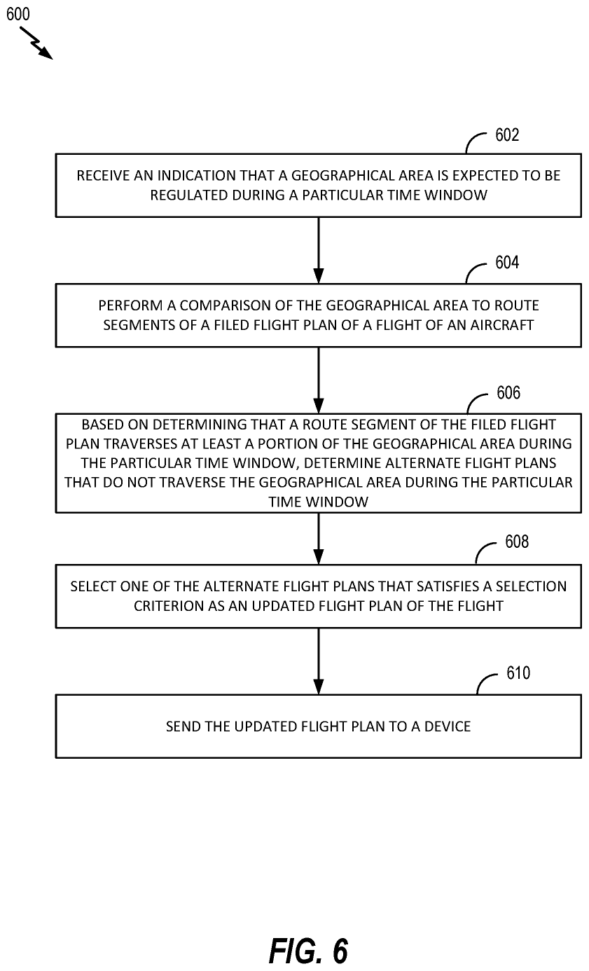

Referring to FIG. 6, an example of a method 600 of updating flight plans based on regulated areas. In a particular aspect, one or more operations of the method 600 can be performed by the flight plan analyzer 174, the one or more processors 170, the device 102, the system 100 of FIG. 1A, the regulated route detector 302, the alternate flight plan generator 304, the flight plan selector 306 of FIG. 3, the pre-configured route selector 568 of FIG. 5A, the candidate route generator 578 of FIG. 5B, or a combination thereof.

The method 600 includes receiving an indication that a geographical area is expected to be regulated during a particular time window, at 602. For example, the flight plan analyzer 174 of FIG. 1A receives the indication 129 that the geographical area 166 is expected to be regulated during the time window 168, as described with reference to FIG.

1A.

The method 600 also includes performing a comparison of the geographical area to route segments of a filed flight plan of a flight of an aircraft, at 604. For example, the regulated route detector 302 of FIG. 3 performs a comparison of the geographical area 166 to the route segment 152A, the route segment 152B, the route segment 152C, and the route segment 152D of the filed flight plan 131 of a flight (e.g., indicated by the flight identifier 120) of the aircraft 108, as described with reference to FIGS. 3 and 4.

The method 600 further includes, based on determining that a route segment of the filed flight plan traverses at least a portion of the geographical area during the particular time window, determining alternate flight plans that do not traverse the geographical area during the particular time window, at 606. For example, based on the regulated route detector 302 of FIG. 3 determining that the route segment 152C and the route segment 152D of the filed flight plan 131 traverse at least a portion of the geographical area 166 during the time window 168, the alternate flight plan generator 304 of FIG. 3 determines the alternate flight plans 133 that do not traverse the geographical area 166 during the time window 168, as described with reference to FIGS. 3, 5A, and 5B.

The method 600 also includes selecting one of the alternate flight plans that satisfies a selection criterion as an updated flight plan of the flight, at 608. For example, the flight plan selector 306 of FIG. 3 selects one of the alternate flight plans 133 (e.g., the alternate flight plan 133C) as the flight plan 135 (e.g., an updated flight plan) of the flight (e.g., indicated by the flight identifier 120), as described with reference to FIGS. 3 and 5B.

The method 600 further includes sending the updated flight plan to a device, at 610. For example, the flight plan analyzer 174 of FIG. 1A sends the flight plan 135 (e.g., the updated flight plan) to the aircraft 108, the one or more devices 104, or a combination thereof.

The method 600 thus enables updating a filed flight plan to reduce a departure delay associated with avoiding a regulated geographical area (e.g., the geographical area 166 during the time window 168). The reduction in departure delay can reduce (e.g., eliminate) an arrival delay, thereby resulting in reduced reactionary flight delays and associated costs.

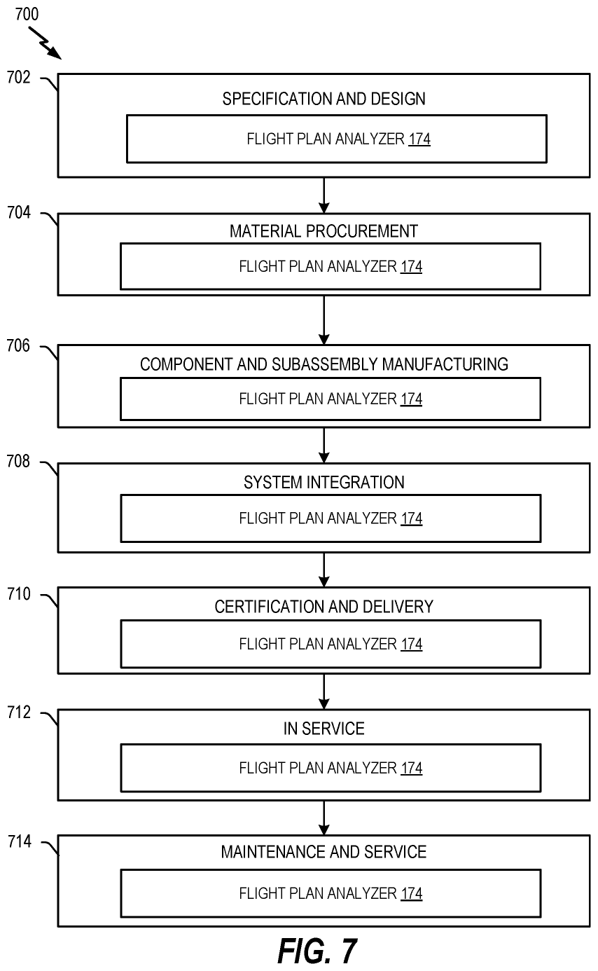

Referring to FIG. 7, a flowchart illustrative of a life cycle of an aircraft that is configured to update flight plans based on regulated areas is shown and designated 700. During pre-production, the exemplary method 700 includes, at 702, specification and design of an aircraft, such as the aircraft 108 described with reference to FIG. 1A. During specification and design of the aircraft, the method 700 may include specification and design of the flight plan analyzer 174. At 704, the method 700 includes material procurement, which may include procuring materials for the flight plan analyzer 174.

During production, the method 700 includes, at 706, component and subassembly manufacturing and, at 708, system integration of the aircraft. For example, the method 700 may include component and subassembly manufacturing of the flight plan analyzer 174 and system integration of the flight plan analyzer 174. At 710, the method 700 includes certification and delivery of the aircraft and, at 712, placing the aircraft in service. Certification and delivery may include certification of the flight plan analyzer 174 to place the flight plan analyzer 174 in service. While in service by a customer, the aircraft may be scheduled for routine maintenance and service (which may also include modification, reconfiguration, refurbishment, and so on). At 714, the method 700 includes performing maintenance and service on the aircraft, which may include performing maintenance and service on the flight plan analyzer 174.

Each of the processes of the method 700 may be performed or carried out by a system integrator, a third party, and/or an operator (e.g., a customer). For the purposes of this description, a system integrator may include without limitation any number of aircraft manufacturers and major-system subcontractors; a third party may include without limitation any number of venders, subcontractors, and suppliers; and an operator may be an airline, leasing company, military entity, service organization, and so on.

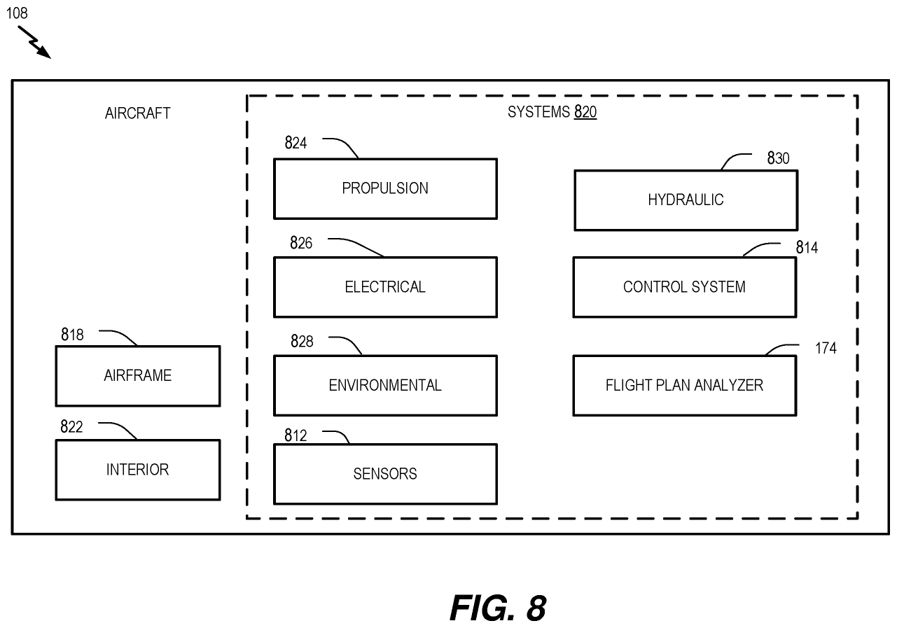

Aspects of the disclosure can be described in the context of an example of a vehicle. A particular example of a vehicle is the aircraft 108 as shown in FIG. 8.

In the example of FIG. 8, the aircraft 108 includes an airframe 818 with a plurality of systems 820 and an interior 822. Examples of the plurality of systems 820 include one or more of a propulsion system 824, an electrical system 826, an environmental system 828, a hydraulic system 830, one or more sensors 812, a control system 814, and the flight plan analyzer 174. Any number of other systems may be included.

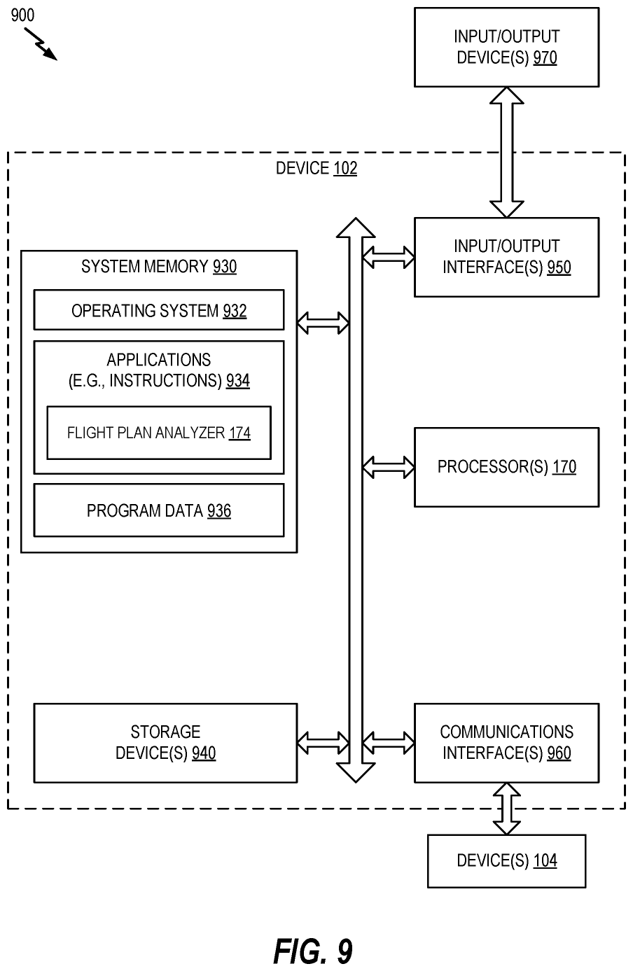

FIG. 9 is a block diagram of a computing environment 900 including the device 102 configured to support aspects of computer-implemented methods and computer-executable program instructions (or code) according to the present disclosure. For example, the device 102, or portions thereof, is configured to execute instructions to initiate, perform, or control one or more operations described with reference to FIGS. 1A-8.

The device 102 includes the one or more processors 170. The processor(s) 170 are configured to communicate with system memory 930, one or more storage devices 940, one or more input/output interfaces 950, one or more communications interfaces 960, or any combination thereof. The system memory 930 includes volatile memory devices (e.g., random access memory (RAM) devices), nonvolatile memory devices (e.g., read-only memory (ROM) devices, programmable read-only memory, and flash memory), or both. The system memory 930 stores an operating system 932, which may include a basic input/output system for booting the device 102 as well as a full operating system to enable the device 102 to interact with users, other programs, and other devices. The system memory 930 stores system (program) data 936, such as the flight identifier 120, the filed flight plan 131, the alternate flight plans 133, the selection criterion 126, the indication 129, the expected departure delay 178, the flight plan 135 of FIG. 1A, the data 200 of FIG. 2, the route segment time window 452, the route segment 450 of FIG. 4, the one or more pre-configured routes 512 of FIG. 5A, the one or more candidate routes 532, any data used or generated by the flight plan analyzer 174, or a combination thereof.

The system memory 930 includes one or more applications 934 (e.g., sets of instructions) executable by the processor(s) 170. As an example, the one or more applications 934 include instructions executable by the processor(s) 170 to initiate, control, or perform one or more operations described with reference to FIGS. 1A-8. To illustrate, the one or more applications 934 include instructions executable by the processor(s) 170 to initiate, control, or perform one or more operations described with reference to the flight plan analyzer 174.

In a particular implementation, the system memory 930 includes a non-transitory, computer readable medium storing the instructions that, when executed by the processor(s) 170, cause the processor(s) 170 to initiate, perform, or control operations to update flight plans based on regulated areas. The operations include receiving an indication that a geographical area is expected to be regulated during a particular time window. The operations also include performing a comparison of the geographical area to route segments of a filed flight plan of a flight of an aircraft. The operations further include, based on determining that a route segment of the filed flight plan traverses at least a portion of the geographical area during the particular time window, determining alternate flight plans that do not traverse the geographical area during the particular time window. The operations also include selecting one of the alternate flight plans that satisfies a selection criterion as an updated flight plan of the flight. The operations further include sending the updated flight plan to a second device.

The one or more storage devices 940 include nonvolatile storage devices, such as magnetic disks, optical disks, or flash memory devices. In a particular example, the storage devices 940 include both removable and non-removable memory devices. The storage devices 940 are configured to store an operating system, images of operating systems, applications (e.g., one or more of the applications 934), and program data (e.g., the program data 936). In a particular aspect, the system memory 930, the storage devices 940, or both, include tangible computer-readable media. In a particular aspect, one or more of the storage devices 940 are external to the device 102.

The one or more input/output interfaces 950 enable the device 102 to communicate with one or more input/output devices 970 to facilitate user interaction. For example, the one or more input/output interfaces 950 can include a display interface, an input interface, or both. For example, the input/output interface 950 is adapted to receive input from a user, to receive input from another computing device, or a combination thereof. In some implementations, the input/output interface 950 conforms to one or more standard interface protocols, including serial interfaces (e.g., universal serial bus (USB) interfaces or Institute of Electrical and Electronics Engineers (IEEE) interface standards), parallel interfaces, display adapters, audio adapters, or custom interfaces (“IEEE” is a registered trademark of The Institute of Electrical and Electronics Engineers, Inc. of Piscataway, New Jersey). In some implementations, the input/output device 970 includes one or more user interface devices and displays, including some combination of buttons, keyboards, pointing devices, displays, speakers, microphones, touch screens, and other devices.

The processor(s) 170 are configured to communicate with the one or more devices 104, the aircraft 108, or a combination thereof, via the one or more communications interfaces 960. For example, the one or more communications interfaces 960 can include a network interface.

In conjunction with the described systems and methods, an apparatus for updating flight plans based on regulated areas is disclosed that includes means for receiving an indication that a geographical area is expected to be regulated during a particular time window. In some implementations, the means for receiving corresponds to the flight plan analyzer 174, the one or more processors 170, the device 102, the system 100, the one or more input/output interfaces 950, the one or more communications interfaces 960, one or more other circuits or devices configured to receive the indication, or a combination thereof.

The apparatus also includes means for performing a comparison of the geographical area to route segments of a filed flight plan of a flight of an aircraft. For example, the means for performing the comparison can correspond to the flight plan analyzer 174, the one or more processors 170, the device 102, the system 100, the regulated route detector 302, one or more other devices configured to perform the comparison, or a combination thereof.

The apparatus further includes means for determining alternate flight plans based on determining that a route segment of the filed flight plan traverses at least a portion of the geographical area during the particular time window, the alternate flight plans do not traverse the geographical area during the particular time window. For example, the means for determining the alternate flight plans can correspond to the flight plan analyzer 174, the one or more processors 170, the device 102, the system 100, the alternate flight plan generator 304, the pre-configured route selector 568, the candidate route generator 578, one or more other devices configured to determine the alternate flight plans, or a combination thereof.

The apparatus also includes means for selecting one of the alternate flight plans that satisfies a selection criterion as an updated flight plan of the flight. For example, the means for selecting one of the alternate flight plans can correspond to the flight plan analyzer 174, the one or more processors 170, the device 102, the system 100, the flight plan selector 306, one or more other devices configured to select one of the alternate flight plans, or a combination thereof.

The apparatus further includes means for sending the updated flight plan to a second device. For example, the means for sending can correspond to the flight plan analyzer 174, the one or more processors 170, the device 102, the system 100, the flight plan selector 306, the one or more input/output interfaces 950, the one or more communications interfaces 960, one or more other devices configured to send the updated flight plan, or a combination thereof.

In some implementations, a non-transitory, computer readable medium stores instructions that, when executed by one or more processors, cause the one or more processors to initiate, perform, or control operations to perform part or all of the functionality described above. For example, the instructions may be executable to implement one or more of the operations or methods of FIGS. 1A-8. In some implementations, part or all of one or more of the operations or methods of FIGS. 1A-8 may be implemented by one or more processors (e.g., one or more central processing units (CPUs), one or more graphics processing units (GPUs), one or more digital signal processors (DSPs)) executing instructions, by dedicated hardware circuitry, or any combination thereof.

Particular aspects of the disclosure are described below in sets of interrelated Examples:

According to Example 1, a device includes: one or more processors configured to: receive an indication that a geographical area is expected to be regulated during a particular time window; perform a comparison of the geographical area to route segments of a filed flight plan of a flight of an aircraft; based on determining that a route segment of the filed flight plan traverses at least a portion of the geographical area during the particular time window, determine alternate flight plans that do not traverse the geographical area during the particular time window; select one of the alternate flight plans that satisfies a selection criterion as an updated flight plan of the flight; and send the updated flight plan to a second device.

Example 2 includes the device of Example 1, wherein the indication is based on predicted aircraft traffic, predicted weather conditions, ground staffing, ground equipment malfunction, military operations, military training, another type of predicted capacity alteration, or any combination thereof.

Example 3 includes the device of Example 1 or Example 2, wherein the indication is based on a notification from an aviation authority.

Example 4 includes the device of any of Example 1 to Example, 3, wherein the updated flight plan is sent to the second device prior to the flight.

Example 5 includes the device of any of Example 1 to Example 4, wherein the second device includes at least one of a flight plan approval device, an aviation authority device, the aircraft, or a ground personnel device.

Example 6 includes the device of any of Example 1 to Example 5, wherein the one or more processors are configured to, in response to determining that the route segment traverses at least the portion of the geographical area: determine, based at least on a planned departure time indicated by the filed flight plan, a route segment time window during which the route segment traverses at least the portion of the geographical area; and based on determining that the route segment time window overlaps the particular time window, determine that the route segment traverses at least the portion of the geographical area during the particular time window.

Example 7 includes the device of any of Example 1 to Example 6, wherein the one or more processors are configured to: receive an expected departure delay associated with the filed flight plan, the expected departure delay to avoid the geographical area during the particular time window; and determine an expected departure time based on the expected departure delay and a planned departure time indicated by the filed flight plan, wherein each of the alternate flight plans has a corresponding departure time that is earlier than the expected departure time.

Example 8 includes the device of Example 7, wherein at least one of the alternate flight plans has a particular departure time that is equal to the planned departure time.

Example 9 includes the device of Example 7 or Example 8, wherein the one or more processors are configured to select a pre-configured route for at least one of the alternate flight plans based on: determining that the pre-configured route is from a departure airport indicated by the filed flight plan to an arrival airport indicated by the filed flight plan; and determining, based on a departure time that is earlier than the expected departure time, that the pre-configured route does not traverse the geographical area during the particular time window.

Example 10 includes the device of any of Example 7 to Example 9, wherein the one or more processors are configured to generate a candidate route based at least in part on a departure airport indicated by the filed flight plan, an arrival airport indicated by the filed flight plan, and one or more candidate way points.

Example 11 includes the device of Example 10, wherein the one or more processors are configured to: determine a candidate geographical region based at least in part on the departure airport and the arrival airport; and select the one or more candidate way points from a plurality of way points based at least in part on determining that each of the one or more candidate way points is included in the candidate geographical region.

Example 12 includes the device of Example 11, wherein the candidate geographical region is further based on the expected departure delay.

Example 13 includes the device of any of Example 10 to Example 12, wherein the one or more processors are configured to select the candidate route for at least one of the alternate flight plans in response to determining, based on a departure time that is earlier than the expected departure time, that the candidate route does not traverse the geographical area during the particular time window.

Example 14 includes the device of any of Example 1 to Example 13, wherein the selection criterion is based on a comparison of arrival times, fuel costs, environmental costs, reactionary costs, or a combination thereof, of the alternate flight plans and the filed flight plan.

According to Example 15, a method includes: receiving, at a first device, an indication that a geographical area is expected to be regulated during a particular time window; performing, at the first device, a comparison of the geographical area to route segments of a filed flight plan of a flight of an aircraft; based on determining that a route segment of the filed flight plan traverses at least a portion of the geographical area during the particular time window, determine alternate flight plans that do not traverse the geographical area during the particular time window; selecting, at the first device, one of the alternate flight plans that satisfies a selection criterion as an updated flight plan of the flight; and sending the updated flight plan from the first device to a second device.

Example 16 includes the method of Example 15, wherein the indication is based on predicted aircraft traffic, predicted weather conditions, ground staffing, ground equipment malfunction, military operations, military training, another type of predicted capacity alteration, or any combination thereof.

Example 17 includes the method of Example 15 or Example 16, wherein the indication is based on a notification from an aviation authority.

Example 18 includes the method of any of Example 15 to Example, 17, wherein the updated flight plan is sent to the second device prior to the flight.

Example 19 includes the method of any of Example 15 to Example 18, wherein the second device includes at least one of a flight plan approval device, an aviation authority device, the aircraft, or a ground personnel device.

Example 20 includes the method of any of Example 15 to Example 19, further including, in response to determining that the route segment traverses at least the portion of the geographical area: determining, based at least on a planned departure time indicated by the filed flight plan, a route segment time window during which the route segment traverses at least the portion of the geographical area; and based on determining that the route segment time window overlaps the particular time window, determining that the route segment traverses at least the portion of the geographical area during the particular time window.

Example 21 includes the method of any of Example 15 to Example 20, further including: receiving, at the first device, an expected departure delay associated with the filed flight plan, the expected departure delay to avoid the geographical area during the particular time window; and determining, at the first device, an expected departure time based on the expected departure delay and a planned departure time indicated by the filed flight plan, wherein each of the alternate flight plans has a corresponding departure time that is earlier than the expected departure time.

Example 22 includes the method of Example 21, wherein at least one of the alternate flight plans has a particular departure time that is equal to the planned departure time.

Example 23 includes the method of Example 21 or Example 22, further including selecting a pre-configured route for at least one of the alternate flight plans based on: determining that the pre-configured route is from a departure airport indicated by the filed flight plan to an arrival airport indicated by the filed flight plan; and determining, based on a departure time that is earlier than the expected departure time, that the pre-configured route does not traverse the geographical area during the particular time window.

Example 24 includes the method of any of Example 21 to Example 23, further including generating a candidate route based at least in part on a departure airport indicated by the filed flight plan, an arrival airport indicated by the filed flight plan, and one or more candidate way points.

Example 25 includes the method of Example 24, further including: determining a candidate geographical region based at least in part on the departure airport and the arrival airport; and selecting the one or more candidate way points from a plurality of way points based at least in part on determining that each of the one or more candidate way points is included in the candidate geographical region.

Example 26 includes the method of Example 25, wherein the candidate geographical region is further based on the expected departure delay.

Example 27 includes the method of any of Example 24 to Example 26, further including selecting the candidate route for at least one of the alternate flight plans in response to determining, based on a departure time that is earlier than the expected departure time, that the candidate route does not traverse the geographical area during the particular time window.

Example 28 includes the method of any of Example 15 to Example 27, wherein the selection criterion is based on a comparison of arrival times, fuel costs, environmental costs, reactionary costs, or a combination thereof, of the alternate flight plans and the filed flight plan.

According to Example 29, a device includes: a memory configured to store instructions; and a processor configured to execute the instructions to perform the method of any of Example 15 to Example 28.

According to Example 30, a non-transitory computer-readable medium stores instructions that, when executed by a processor, cause the processor to perform the method of any of Example 15 to Example 28.

According to Example 31, an apparatus includes means for carrying out the method of any of Example 15 to Example 28.

According to Example 32, a non-transitory computer-readable medium storing instructions that, when executed by one or more processors, cause the one or more processors to: receive an indication that a geographical area is expected to be regulated during a particular time window; perform a comparison of the geographical area to route segments of a filed flight plan of a flight of an aircraft; based on determining that a route segment of the filed flight plan traverses at least a portion of the geographical area during the particular time window, determine alternate flight plans that do not traverse the geographical area during the particular time window; select one of the alternate flight plans that satisfies a selection criterion as an updated flight plan of the flight; and send the updated flight plan to a second device.

Example 33 includes the non-transitory computer-readable medium of Example 32, wherein the instructions, when executed by the one or more processors, further cause the one or more processors to: determine a candidate geographical region based at least in part on a departure airport indicated by the filed flight plan and an arrival airport indicated by the filed flight plan; select one or more candidate way points from a plurality of way points based at least in part on determining that each of the one or more candidate way points is included in the candidate geographical region; and generate a candidate route based at least in part on the departure airport, the arrival airport, and the one or more candidate way points.

The illustrations of the examples described herein are intended to provide a general understanding of the structure of the various implementations. The illustrations are not intended to serve as a complete description of all of the elements and features of apparatus and systems that utilize the structures or methods described herein. Many other implementations may be apparent to those of skill in the art upon reviewing the disclosure. Other implementations may be utilized and derived from the disclosure, such that structural and logical substitutions and changes may be made without departing from the scope of the disclosure. For example, method operations may be performed in a different order than shown in the figures or one or more method operations may be omitted. Accordingly, the disclosure and the figures are to be regarded as illustrative rather than restrictive.

Moreover, although specific examples have been illustrated and described herein, it should be appreciated that any subsequent arrangement designed to achieve the same or similar results may be substituted for the specific implementations shown. This disclosure is intended to cover any and all subsequent adaptations or variations of various implementations. Combinations of the above implementations, and other implementations not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single implementation for the purpose of streamlining the disclosure. Examples described above illustrate but do not limit the disclosure. It should also be understood that numerous modifications and variations are possible in accordance with the principles of the present disclosure. As the following claims reflect, the claimed subject matter may be directed to less than all of the features of any of the disclosed examples. Accordingly, the scope of the disclosure is defined by the following claims and their equivalents.

What is claimed is:

1. A device comprising:
one or more processors configured to:
receive an indication that a geographical area is expected to be regulated during a particular time window;
perform a comparison of the geographical area to route segments of a filed flight plan of a flight of an aircraft;
based on determining that a route segment of the filed flight plan traverses at least a portion of the geographical area during the particular time window, determine alternate flight plans that do not traverse the geographical area during the particular time window;
select one of the alternate flight plans that satisfies a selection criterion as an updated flight plan of the flight; and
send the updated flight plan to a second device.

2. The device of claim 1, wherein the indication is based on predicted aircraft traffic, predicted weather conditions, ground staffing, ground equipment malfunction, military operations, military training, another type of predicted capacity alteration, or any combination thereof.

3. The device of claim 1, wherein the indication is based on a notification from an aviation authority.

4. The device of claim 1, wherein the updated flight plan is sent to the second device prior to the flight.

5. The device of claim 1, wherein the second device includes at least one of a flight plan approval device, an aviation authority device, the aircraft, or a ground personnel device.

6. The device of claim 1, wherein the one or more processors are configured to, in response to determining that the route segment traverses at least the portion of the geographical area:
determine, based at least on a planned departure time indicated by the filed flight plan, a route segment time window during which the route segment traverses at least the portion of the geographical area; and
based on determining that the route segment time window overlaps the particular time window, determine that the route segment traverses at least the portion of the geographical area during the particular time window.

7. The device of claim 1, wherein the one or more processors are configured to:
receive an expected departure delay associated with the filed flight plan, the expected departure delay to avoid the geographical area during the particular time window; and
determine an expected departure time based on the expected departure delay and a planned departure time indicated by the filed flight plan, wherein each of the alternate flight plans has a corresponding departure time that is earlier than the expected departure time.

8. The device of claim 7, wherein at least one of the alternate flight plans has a particular departure time that is equal to the planned departure time.

9. The device of claim 7, wherein the one or more processors are configured to select a pre-configured route for at least one of the alternate flight plans based on:
determining that the pre-configured route is from a departure airport indicated by the filed flight plan to an arrival airport indicated by the filed flight plan; and
determining, based on a departure time that is earlier than the expected departure time, that the pre-configured route does not traverse the geographical area during the particular time window.

10. The device of claim 7, wherein the one or more processors are configured to generate a candidate route based at least in part on a departure airport indicated by the filed flight plan, an arrival airport indicated by the filed flight plan, and one or more candidate way points.

11. The device of claim 10, wherein the one or more processors are configured to:
determine a candidate geographical region based at least in part on the departure airport and the arrival airport; and
select the one or more candidate way points from a plurality of way points based at least in part on determining that each of the one or more candidate way points is included in the candidate geographical region.

12. The device of claim 11, wherein the candidate geographical region is further based on the expected departure delay.

13. The device of claim 10, wherein the one or more processors are configured to select the candidate route for at least one of the alternate flight plans in response to determining, based on a departure time that is earlier than the expected departure time, that the candidate route does not traverse the geographical area during the particular time window.

14. The device of claim 1, wherein the selection criterion is based on a comparison of arrival times, fuel costs, environmental costs, reactionary costs, or a combination thereof, of the alternate flight plans and the filed flight plan.

15. A method comprising:
receiving, at a first device, an indication that a geographical area is expected to be regulated during a particular time window;
performing, at the first device, a comparison of the geographical area to route segments of a filed flight plan of a flight of an aircraft;
based on determining that a route segment of the filed flight plan traverses at least a portion of the geographical area during the particular time window, determine alternate flight plans that do not traverse the geographical area during the particular time window;
selecting, at the first device, one of the alternate flight plans that satisfies a selection criterion as an updated flight plan of the flight; and
sending the updated flight plan from the first device to a second device.

16. The method of claim 15, further comprising, in response to determining that the route segment traverses at least the portion of the geographical area:
determining, based at least on a planned departure time indicated by the filed flight plan, a route segment time window during which the route segment traverses at least the portion of the geographical area; and
based on determining that the route segment time window overlaps the particular time window, determining that the route segment traverses at least the portion of the geographical area during the particular time window.

17. The method of claim 15, further comprising:
receiving, at the first device, an expected departure delay associated with the filed flight plan, the expected departure delay to avoid the geographical area during the particular time window; and
determining, at the first device, an expected departure time based on the expected departure delay and a planned departure time indicated by the filed flight plan,
wherein each of the alternate flight plans has a corresponding departure time that is earlier than the expected departure time.

18. The method of claim 17, further comprising selecting a pre-configured route for at least one of the alternate flight plans based on:
determining that the pre-configured route is from a departure airport indicated by the filed flight plan to an arrival airport indicated by the filed flight plan; and
determining, based on a departure time that is earlier than the expected departure time, that the pre-configured route does not traverse the geographical area during the particular time window.

19. A non-transitory computer-readable medium storing instructions that, when executed by one or more processors, cause the one or more processors to:
receive an indication that a geographical area is expected to be regulated during a particular time window;
perform a comparison of the geographical area to route segments of a filed flight plan of a flight of an aircraft;
based on determining that a route segment of the filed flight plan traverses at least a portion of the geographical area during the particular time window, determine alternate flight plans that do not traverse the geographical area during the particular time window;
select one of the alternate flight plans that satisfies a selection criterion as an updated flight plan of the flight; and
send the updated flight plan to a second device.

20. The non-transitory computer-readable medium of claim 19, wherein the instructions, when executed by the one or more processors, further cause the one or more processors to:
determine a candidate geographical region based at least in part on a departure airport indicated by the filed flight plan and an arrival airport indicated by the filed flight plan;
select one or more candidate way points from a plurality of way points based at least in part on determining that each of the one or more candidate way points is included in the candidate geographical region; and
generate a candidate route based at least in part on the departure airport, the arrival airport, and the one or more candidate way points.
